(19) United States
(12) Patent Application Publication
(10) Pub. No.: US 2004/0146384 A1
(43) Pub. Date: Jul. 29, 2004

(54) Method and apparatus for moving a vehicle

(76) Inventor: Patrick J. Whelan, Troutdale, OR (US)

Correspondence Address: MARGER JOHNSON & McCOLLOM. P.C., 1030 S.W. Morrison Street, Portland, OR, 97205, US

(21) Appl. No.: 10/627,846

(22) Filed: Jul. 24, 2003

Related U.S. Application Data
(60) Provisional application No. 60/398,433, filed on Jul. 24, 2002.

(51) Int. Cl. B65G 7/00

(52) U.S. Cl. 414/426

(57) ABSTRACT

An apparatus according to embodiments of the invention includes a set of moveable jaws mounted to a frame. One or both of the jaws may include a lifting roller. When properly operated, the jaws can be brought together to lift and cradle a wheel of a vehicle or trailer. Once lifted, a powered device such as a wheel, which is also mounted to the frame, can be energized to move the entire vehicle or trailer.

### TECHNICAL FIELD

This disclosure relates to a mechanical device, and, more particularly, to a mechanical device for moving a vehicle.

### BACKGROUND OF THE INVENTION

A vehicle, by definition, is a mobile object. Motor vehicles, such as automobiles, trucks and semi-trucks are self powered in that they contain a motor or other power means coupled through a transmission to wheels of the vehicle. Thus, motor vehicles are capable of self locomotion. Typically, trailers and similar vehicles must be attached to another vehicle because they lack their own power source. Generally, trailers are pulled behind a motor vehicle, such as a car, truck or semi-truck.

Occasionally, mechanical breakdowns occur and motor vehicles become disabled. For instance, a motor could stop operating or a transmission could fail to transmit power. Unless power can be generated and transmitted to the wheels of a motor vehicle, the motor vehicle is not capable of self movement. Trailers, as mentioned above, generally do not include a self-powering mechanism and must therefore always be moved by applying power from another source.

Typical methods for moving a disabled motor vehicle include pushing, pulling or towing the disabled vehicle with a second vehicle. Moving trailers typically involves pulling or towing the trailer.

Sometimes it is inconvenient to move one vehicle with another. Towing-type vehicles are generally expensive and difficult to operate. Also, because it is not the purpose of motor vehicles to be towed, damage can occur when attaching the disabled vehicle to the tow vehicle, or during the towing itself. Additionally, motor vehicles are not primarily designed to be pushed or pulled, and damage to the front or rear of the vehicle may also occur during such action. Although trailers are intended to be pulled by another vehicle, sometimes no pulling vehicle is available. When this occurs, the trailer typically cannot be moved.

Additionally, most motor vehicles and trailers are wheeled vehicles, and generally have pneumatic tires mounted on the wheels. The tires provide a cushioning effect to the vehicle for traveling over uneven surfaces. Although modern tires are relatively strong, they are not infallible, and occasionally develop blowouts, leaks, holes, punctures, flats, loss of tread, or otherwise become unusable. When a tire is not operational, moving a vehicle becomes especially inconvenient because it is difficult to move the vehicle without causing further damage to the tire. In other words, the entire vehicle is typically immobilized by the non-functioning tire.

Embodiments of the invention address these and other deficiencies.

### BRIEF DESCRIPTION OF THE DRAWINGS

The description may be best understood by reading the disclosure with reference to the accompanying drawings.

FIG. 1 is a isometric view drawing of a self-powered vehicle mover according to an embodiment of the invention.

FIG. 2 is a rear view drawing of the vehicle mover of FIG. 1 in position for moving an automobile.

FIG. 3 is a rear view drawing of the vehicle mover of FIG. 1 in position for moving a boat trailer.

FIG. 4 is a rear view drawing of the vehicle mover of FIG. 1 in position for moving a camping trailer.

FIG. 5 is a side view drawing of the vehicle mover of FIG. 1 illustrating one way to transport the mover.

FIG. 6A is a front view drawing of the vehicle mover of FIG. 1 illustrating its position relative to a vehicle tire prior to operation.

FIG. 6B is a front view drawing, similar to FIG. 6A, except showing the vehicle tire in a position lifted by the vehicle mover.

FIG. 7 is a top view drawing showing components of the vehicle mover of FIG. 1.

FIG. 8 is a rear view drawing showing components of the vehicle mover of FIG. 1.

### DETAILED DESCRIPTION OF THE PREFERRED EMBODIMENTS

A vehicle mover according to embodiments of the invention includes a set of moveable jaws mounted to a frame. One or both of the jaws may include a lifting roller. When properly operated, the jaws can lift and cradle a wheel of a vehicle or trailer. Once lifted, a powered wheel, which is also mounted to the frame, can be energized to move the entire vehicle or trailer.

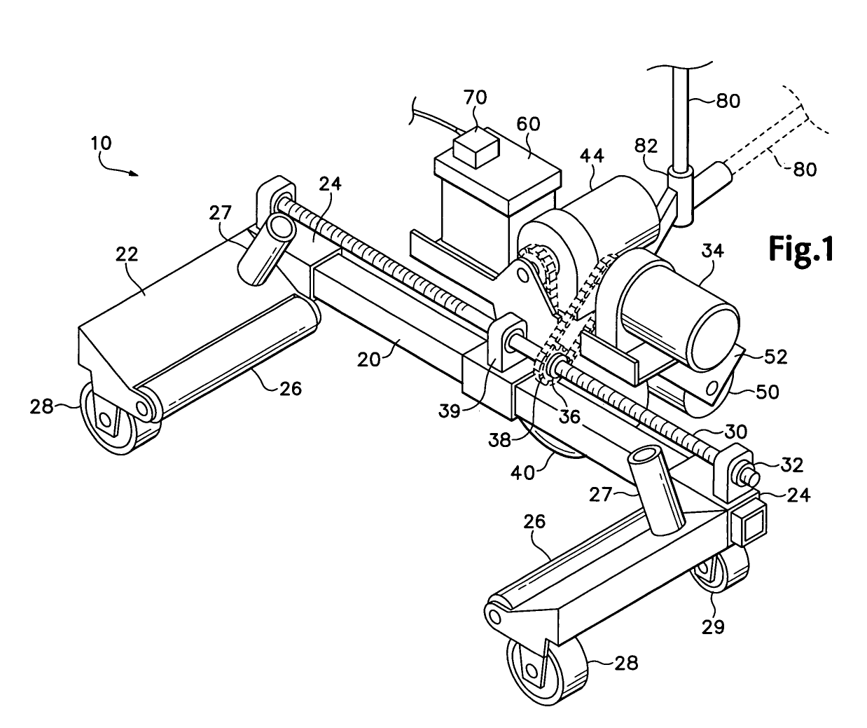

Referring to FIG. 1, a vehicle mover according to an embodiment of the invention is generally indicated by reference 10. A frame 20 has a generally elongated shape and a pair of moveable jaws 22 are attached, respectively, at the ends of the frame.

An individual jaw 22 includes a sliding end 24 having an opening for accepting a portion of the frame 20 therethrough. Additionally, each jaw 22 includes a supporting wheel 28 mounted to the under-side of the jaw on an end of the jaw opposite to the sliding end 24. The supporting wheels 28 may be caster mounted to the jaw 22, such that they are not limited in the direction of travel. The jaws 22 are formed to travel longitudinally along the frame 20, with each individual jaw able to travel between near the center of the frame out toward a respective end of the frame. The jaws 22 may move separately or in concert.

In the embodiment shown in FIG. 1, a threaded rod 30 engages a threaded nut 32 or other threaded device mounted at the open end 24 of each of the jaws 22. The threaded rod 30 is mechanically coupled to a jaw motor 34 such as by a chain 36 and sprocket 38. Due to the chain and sprocket arrangement 36, 38, when the motor 34 operates, the threaded rod 30 also rotates. Of course, other methods of coupling the threaded rod 30 to the motor 34 are known, such as a by using a direct drive, gearbox, transmission, a belt and pulley, or by using a ribbed belt and notched pulley system, and all would be equally acceptable.

In operation, when the motor 34 is energized to spin the rod 30 in a first direction, pressure is exerted on the threads of the nuts 32 which draws both jaws 22 toward the center of the frame 20. Conversely, when the motor 34 spins in the opposite direction, the jaws 22 are pushed toward the ends of the frame 20. In some embodiments, operation of the motor 34 is controlled by a switch (not shown) mounted on the vehicle mover 10.

During the jaw moving process, as the threaded rod 30 rotates, the frame 20 slides through the sliding end 24 of the jaws 22. The direction and amount of distance the jaws 22 slide along the frame 20 is determined by controlling the spinning direction and length of operation of the motor 34. If the vehicle mover 10 is resting on a ground surface in its normal operating position, the support wheels 28 on each jaw 22 roll along the ground surface as the jaws 22 move, thereby providing support for the vehicle mover. A set of auxiliary wheels 29, which are mounted to the jaws opposite from the support wheels 28 are preferably smaller than the support wheels. As with the support wheels 28, the auxiliary wheels 29 may be caster mounted to the frame. The auxiliary wheels 29 generally do not support the vehicle mover 10, although they can add stability when moving a vehicle over uneven or un-level terrain. In other embodiments of the invention, the auxiliary wheels 29 are not necessary, and are not included.

Because in the preferred embodiment only a single threaded rod 30 controls two jaws 22, one end of the threaded rod 30 has right handed threads while the other end has left handed threads. Similarly, the nut 32 in the jaw 22 that engages the right hand threads of the threaded rod 30 is a right hand thread nut, while the other nut 32 is a left hand thread nut. Therefore, when spinning in only one direction, each jaw 22 moves in opposite directions relative to the frame 20. Put differently, as the threaded rod 30 spins in a first direction, the jaws 22 move toward each other; and when the threaded rod spins 30 in the opposite direction, the jaws 22 move away from each other.

The threaded rod 30 of the vehicle mover 10 may include caps or bushings to limit the length of travel of the jaws 22. Additionally, the nut 32 can be made of a softer material than the threaded rod 30 itself, such that if the jaws 22 bind or are otherwise prohibited from traveling, one or both of the nuts 32 can shear under the stress from the threads of the rod, without causing any damage to the rod itself. Thus, if this happens, the sheared nut 32 can be replaced more easily and less expensively than replacing the entire threaded rod 30.

The threaded rod 30 is supported at either end of the rod by the nuts 32, and supported in the middle of the frame 20 by a bearing 39, thus allowing the rod to easily spin. Additionally, for safety and protection, a boot or cover protects the threads of the threaded rod 30 from being exposed, and a chain shroud covers the chain and sprocket 36, 38. For clarity, neither the rod cover nor chain shroud is shown in FIG. 1.

Although shown in FIG. 1 as a threaded system, any system that could cause linear travel of one or both of the jaws 22 relative to the frame 20 is acceptable for embodiments of the invention. For instance, a hydraulic system or compressed air system mounted to the frame 22 could be used to move either or both of the jaws 22 instead of the rotating threaded rod 30, with no difference in functionality of operation. Or, a mechanical system, such as a jacking system could be used to cause the jaws 22 to close.

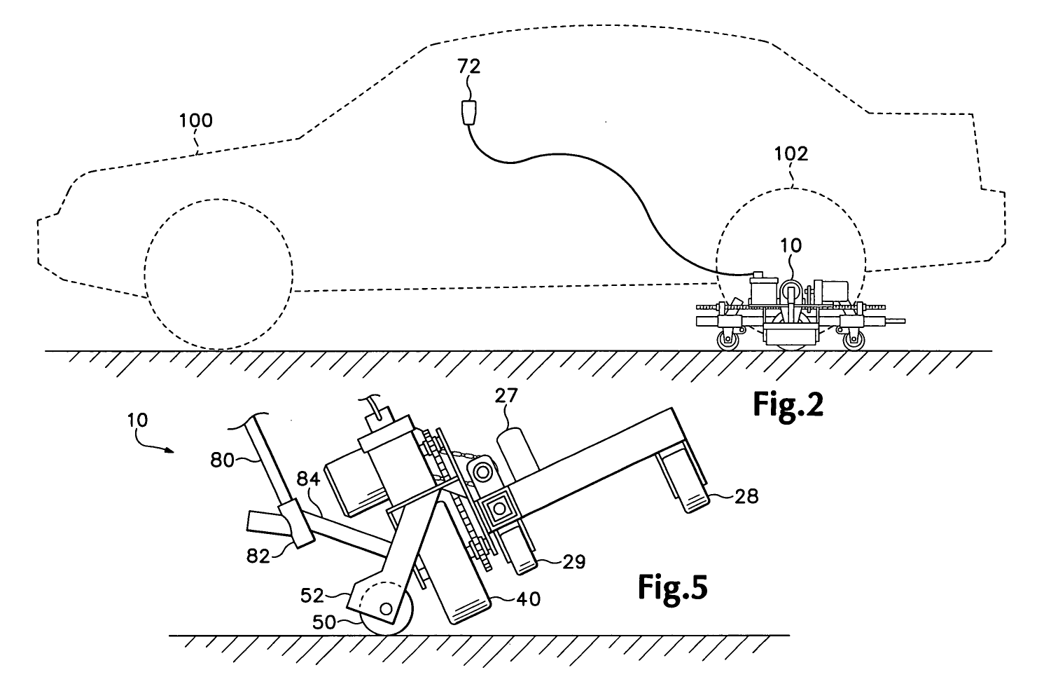

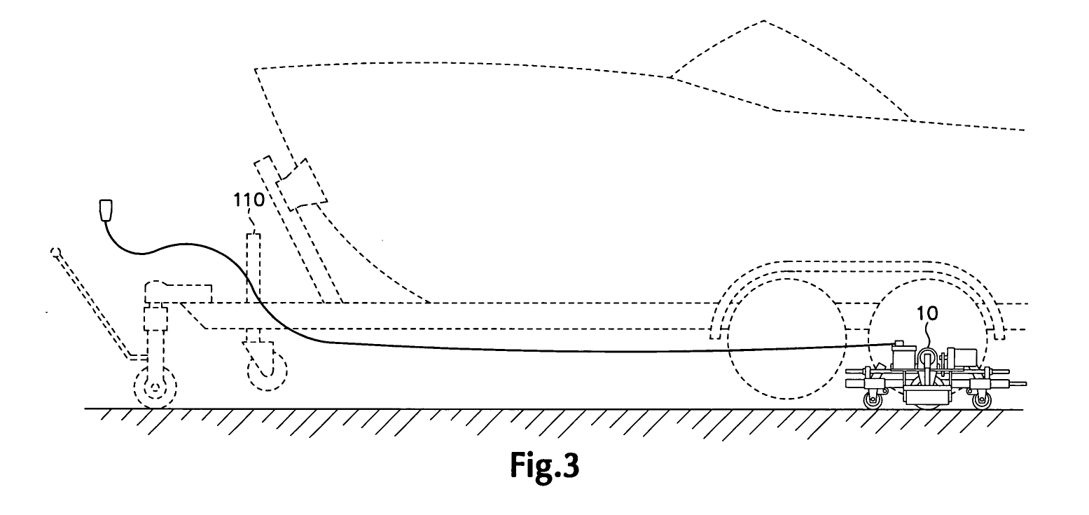

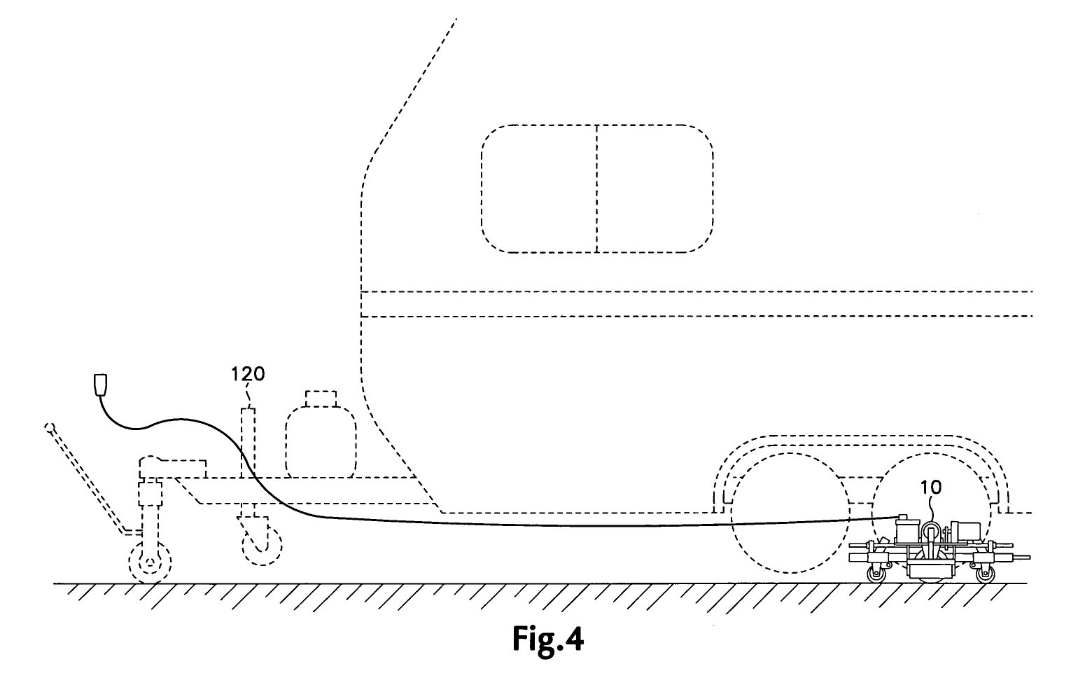

FIG. 2 is a rear view drawing of the vehicle mover 10 showing the vehicle mover in position to move an automobile 100. Similarly FIGS. 3 and 4 show the vehicle mover 10 in position to move a boat trailer 110 and a camping trailer 120, respectively. In FIGS. 3 and 4 both of the trailers 110, 120 are shown as tandem trailers, i.e. having two rear axels. Additionally the vehicle mover 10 is shown as being positioned for lifting a wheel at the rear of the two axels. The vehicle mover 10 could be positioned to lift a wheel mounted to either of the tandem axels, however. Also a trailer need not be a tandem axel trailer to be moved by the vehicle mover 10.

FIG. 5 illustrates how the vehicle mover 10 itself can be positioned near a wheel of a vehicle. The vehicle mover 10 includes a wheel 50, for example a cylinder shaped wheel mounted to a frame member 52. The frame member 52, in turn, is mounted to the frame 20 of FIG. 1. A handle 80 is held in a receiver 82 that is coupled to another frame member 84. The frame member 84 is also mounted to the frame 20, either by a direct mount, or by being attached to the frame member 52. The receiver 82 may have multiple openings to accommodate the handle 80 in various positions.

To move the vehicle mover 10, the handle 80 is first inserted into one of the openings in the receiver 82. Then, a lifting force is exerted on the handle 80 to rock the mover back such that it is supported by, or balances on the cylinder wheel 50. Once the vehicle mover is so balanced, it can be relatively easily guided into position for moving a vehicle as shown in FIGS. 2-4. The cylinder wheel 50, of course need not be cylinder shaped. In embodiments of the invention a cylinder shaped wheel is used to provide stability to the vehicle mover 10 when moving it. Two or more separate wheels mounted to the frame member 52 could be easily substituted for the cylinder wheel 50 without deviating from the spirit of the invention. Additionally, if a bracket to which the support wheels 28 are mounted could be made to swivel, such as by using a caster type bracket, the vehicle mover could roll on the support wheels 28 themselves. In such a configuration, a pushing or lifting force would be applied to the handle 80 rather than a pulling force as described above.

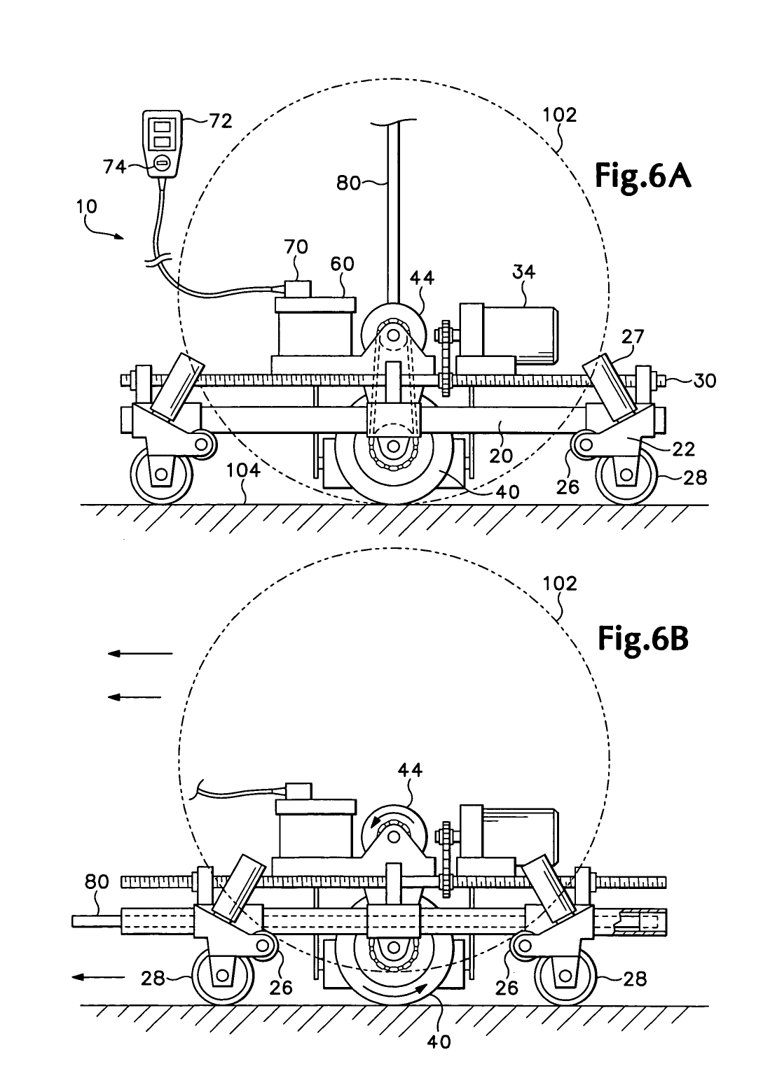

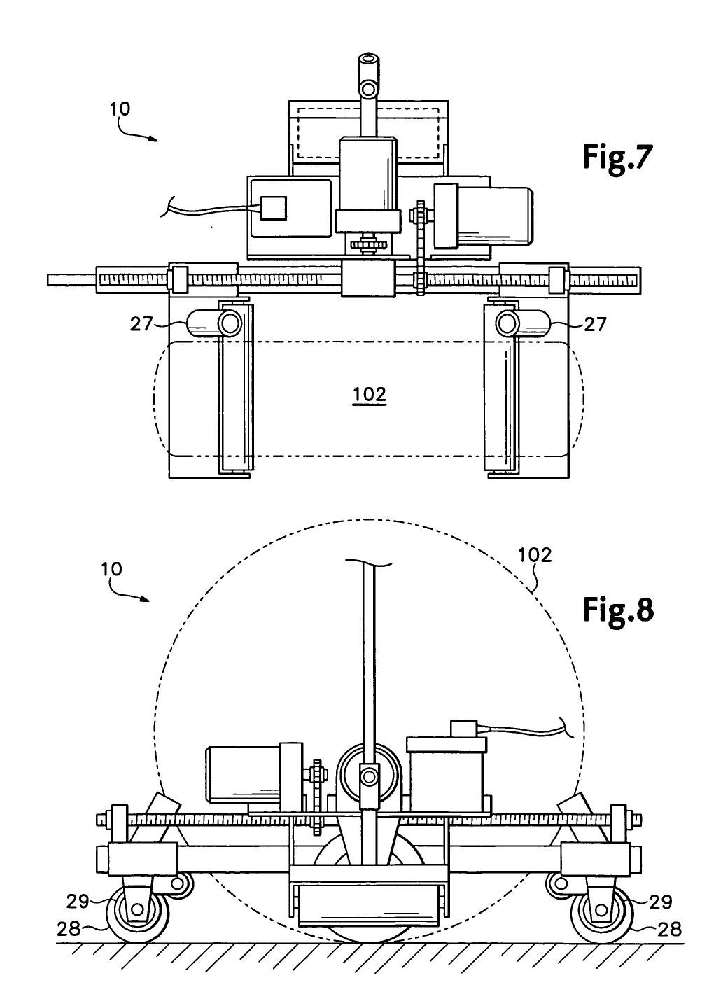

FIGS. 6A and 6B illustrate the lifting and moving operations of the vehicle mover 10. In FIG. 6A, the vehicle mover 10 is positioned adjacent to a round object, for example a tire 102 resting on a ground surface 104. The tire 102 would generally be mounted on a wheel attached to a vehicle, such as the automobile 100 of FIG. 2, for instance. In a starting position, the jaws 22 are positioned near the ends of the frame 20, or at least wide enough so that there is little or no contact between the rollers 26 and the tire 102. Additionally, the vehicle mover 10 may be positioned such that the tire 102 is near or resting on a set of bumpers 27, which are mounted to the jaws 22. FIG. 7 is an overhead view showing the placement of the vehicle mover 10 relative to the tire 102.

Once in proper position, the handle 80 may be removed from its receiver 82 and, for convenience, stored within the frame 20, as shown in FIG. 6B. In some embodiments of the invention, the handle 80 includes threads that screw into the receiver 82, and also screw into a threaded handle holder 86 that is mounted within the frame 20.

Referring back to FIG. 6A, once properly positioned, the jaw motor 34 is energized by, for example, controlling an appropriate switch, button or buttons on a controller 72 that is coupled to the motor 34. The switch controlling the motor 34 could also be mounted to or coupled to the vehicle mover 10. When the motor 34 is so controlled, the threaded rod 32 spins as described above. This, in turn, causes the jaws 22 to move toward the center of the frame 20. As shown in FIG. 6B, as the jaws 22 are brought closer to one another, the rollers 26 contact the tire 102. As the jaws are moved further inward, the low position of the rollers 26 relative to the tire 102, combined with the curvature of the tire itself creates a lifting force. Thus, by moving the jaws 22 even closer together, the tire 102 is lifted such that it is no longer contacting the ground surface 104. Lifting and cradling a tire 102 as described above is also sometimes referred to as “dollying” the tire.

When the tire 102 is in the lifted position, as illustrated in FIG. 6B, in a preferred embodiment of the vehicle mover 10 the majority of the weight of the tire 102 and the vehicle to which it is attached is supported by the moving wheel 40. The weight of the vehicle on the moving wheel 40 provides good traction to the moving wheel 40. Additionally, the weight is supported in tripod fashion by the moving wheel 40, and the pair of support wheels 28. Because the auxiliary wheels 29 are, in some embodiments, smaller than the support wheels 28, the auxiliary wheels 29 may not touch the ground when the vehicle mover is in operating position. Of course, if the vehicle mover 10 is operating on uneven terrain, the auxiliary wheels could touch the ground and provide support to the vehicle mover 10.

Once the tire 102 is lifted from the ground surface 104, the vehicle mover 10 can be used to move the entire vehicle 100 (FIG. 2). To enable such a movement, the vehicle should have little or no hindrance to rolling. For instance, the vehicle 100 could have its transmission in “neutral” and have no wheel brakes applied. Then, after the tire 102 has been raised from the ground surface 104 a proper distance, a moving motor 44 can be caused to rotate, such as, for example, pressing appropriate control buttons on the controller 72. The moving motor 44 is coupled to a power device, such as a moving tire 40, which, in addition to the support wheels 28, rests on the ground surface 104. Rotating the moving tire 40 across the ground surface causes both the vehicle mover 10 and the actual vehicle 100 to which the vehicle mover is supporting, to be moved—wholly by the power of the moving motor 44.

The tire 40 need not actually be a tire, of course. The moving motor 44 could instead be coupled to other types of structures for moving the vehicle mover 10. For instance, the moving motor 44 could be coupled to a crawler track, for instance those often used in dirt moving machinery. Or, the moving motor could be coupled to a compound-type wheel, which would allow the vehicle mover 10 to move over uneven terrain. Any mechanism coupled to the moving motor 44 that can efficiently move the vehicle mover 10 is acceptable.

A remote, such as the wired remote 72 shown in FIG. 6A, may be used to control the moving motor 44, and may additionally be used to operate the jaws 22. This enables a single person to completely operate the vehicle mover 10, i.e., a single person can position the vehicle mover, raise the vehicle, then control the moving motor 44 by, for instance, using the remote 72.

As shown in FIG. 2, an operator of the vehicle mover 10 can hold the remote 72 while sitting in the automobile 100. Then, by selecting an appropriate button on the remote 72, the operator can control the moving motor 44 to rotate in either a forward or rearward direction. This gives complete independence to an operator of the vehicle mover 10 in that a single operator can completely use the vehicle mover 10 to move a vehicle, without requiring assistance from another person. As such, the vehicle mover 10 can lower operating costs by minimizing personnel expenses.

Generally, when moving a vehicle, the operator sits in the driver's seat so that the vehicle can be steered while it is moving. Typically, the vehicle mover 10 will lift and support the rear wheel on the driver's side, so that an operator can see the vehicle mover in operation.

If, for some reason, the vehicle mover 10 is mounted on the side of the vehicle opposite the driver, then the “forward” button on the remote 72 causes the vehicle mover 10 to move the vehicle in reverse, and the “reverse” button on the remote causes the vehicle forward. This is because of the way the moving tire 40 spins relative to the vehicle. A safety 74 mounted to the remote 72 can be used to prevent operation of the vehicle mover when it is unsafe, such as when the vehicle mover is being positioned near the tire 102. The remote 72 couples to a control box 70, which is used to properly energize the moving motor 44 based on the signals received from the remote. Additionally, in some embodiments, the control for the jaws 22 is also located on the remote 72.

Power for both the moving motor 44 and the jaw motor 34 is provided by a battery 60 that is mounted to the vehicle mover 10. Power cables for coupling the battery 60 to the motors 34, 44 have been omitted for clarity. If more power than can be supplied by a battery is desired, or if otherwise convenient, a gasoline or other type motor could be substituted for the electric moving motor 44. Any method of providing power to the moving wheel 40 is acceptable, as long as the method can be controlled by an operator of the vehicle mover 10. For example, a hydrostatic transmission running from a hydraulic pump could be used.

FIGS. 7 and 8 are top and rear view drawings, respectively, showing additional details of the vehicle mover and its position relative to a vehicle tire being moved. As mentioned above, shrouds, covers, and boots that could cover the exposed sprockets, chains, and rods are omitted for clarity.

Embodiments of the invention shown and described herein are not limiting to the invention itself, and the inventive concept of this invention is meant to be considered broadly.

What is claimed is:

1. An apparatus for moving a vehicle, comprising:
a frame;
a set of moveable jaws slideably coupled to the frame and structured to lift a wheel of such a vehicle; and
a mobilization device mounted to the frame and, when powered, structured to cause the apparatus and the vehicle to move.

2. The apparatus of claim 1 wherein at least one of the moveable jaws is threadedly coupled to the frame.

3. The apparatus of claim 2 wherein at least one of the jaws is coupled to a threaded rod supported on the frame.

4. The apparatus of claim 1 wherein the powered mobilization device comprises:
a motor; and
a wheel engageable to the motor.

5. The apparatus of claim 4 wherein the motor is fixedly engaged to the wheel.

6. The apparatus of claim 1 wherein the mobilization device comprises:
a motor having a shaft
a first sprocket coupled to the shaft of the motor;
a wheel;
a second sprocket coupled to the wheel; and
a chain that mechanically links the first sprocket to the second sprocket.

7. The apparatus of claim 1 wherein the set of moveable jaws each include a main support wheel.

8. The apparatus of claim 7 wherein each of the main support wheels is caster mounted to the frame.

9. The apparatus of claim 7 wherein, when the wheel is lifted, only the main support wheels and the mobilization device contact a ground surface.

10. An apparatus, comprising:
a frame;
a first and a second jaw each having a first end and a second end, the first end of the jaws moveably coupled to the frame, and the second end of the jaws having a main support wheel, the first and second jaw structured to cause an object placed between them to lift as the jaws are closed; and
a mobilization device mounted to the frame;
wherein, when the apparatus is in position to lift the object, only the main support wheels and the mobilization device touch a ground surface.

11. The apparatus of claim 10 wherein the mobilization device comprises:
a motor; and
a wheel coupleable to the motor.

12. The apparatus of claim 11, further comprising a remote control structured to control the motor.

13. The apparatus of claim 10 wherein the mobilization device comprises:
a motor having a shaft
a first sprocket coupled to the shaft of the motor;
a wheel;
a second sprocket coupled to the wheel; and
a chain that mechanically links the first sprocket to the second sprocket.

14. The apparatus of claim 13, further comprising a remote control structured to control the mobilization device.

15. An apparatus, comprising:
means for dollying a round object by closing two opposed jaws; and
powered means for moving the apparatus and the dollied round object.

16. The apparatus of claim 15 wherein at least one of the two opposed jaws comprises a roller to support the round object.

17. The apparatus of claim 15 wherein the powered means comprises a motorized wheel.

18. A vehicle moving apparatus, comprising:
an elongated frame having a first end and a second end;
a pair of jaws, mounted to respective ends of the frame, at least one jaw slideably coupled to the frame in a first portion, each jaw having a main support wheel in a second portion, and at least one jaw having a roller located between the first portion and the second portion; and
a drive wheel coupled to the frame and structured to be powered by a drive motor.

19. The apparatus of claim 18, further comprising a powered jaw closing mechanism attached to the frame and to the pair of jaws and structured to open and close the jaws.

20. The apparatus of claim 19 wherein the powered jaw closing mechanism comprises:
a threaded rod coupled to a jaw motor; and
a threaded receiver attached to each of the jaws, wherein rotating the threaded rod causes at least one of the jaws to slide along the frame.

21. A method of moving an object resting on a ground surface, comprising
positioning a vehicle mover proximate the object;
controlling a pair of opposed jaws on the vehicle mover to close until the object is raised from the ground surface; and
operating a powered moving mechanism that is attached to the vehicle mover.

22. The method of claim 21 wherein controlling a pair of opposed jaws comprises operating a motor-controlled jaw-opener.

23. The method of claim 21 wherein operating a powered moving mechanism comprises operating a motor-powered wheel.

24. The method of claim 21 wherein operating a powered moving mechanism comprises controlling a remote control device coupled to the moving mechanism.

25. The method of claim 24 wherein the remote control device is located inside of a vehicle.
